(19) United States
(12) Patent Application Publication
(10) Pub. No.: US 2011/0129590 A1
(43) Pub. Date: Jun. 2, 2011

(54) Beverage Product with Resveratrol

(76) Inventors: Kathryn Deibler, White Plains, NY (US); Cliff Oster, Langdon, NH (US); Jonathan Straub, Haverford, PA (US)

(21) Appl. No.: 12/787,890

(22) Filed: May 26, 2010

Related U.S. Application Data
(60) Provisional application No. 61/181,437, filed on May 27, 2009.

(51) Int. Cl. A23L 2/38

(52) U.S. Cl. 426/599; 426/590

(57) ABSTRACT

A beverage product including water and a resveratrol solution, where the resveratrol solution contains a carrier solvent and about 0.5 wt % to about 10 wt % resveratrol. A method of producing a beverage product, including adding a resveratrol solution to a beverage solution, where the resveratrol solution contains a carrier solvent and about 0.5 wt % to about 10 wt % resveratrol.

### CROSS-REFERENCE TO RELATED APPLICATION

This application claims priority to U.S. Provisional Patent Application No. 61/181,437, filed on May 27, 2009, the contents of which are fully incorporated herein by reference.

### BACKGROUND

It has long been known to produce beverages of various formulations. Improved and new formulations are desirable to meet changing market demands.

Resveratrol is a phytoalexin produced naturally or by chemical synthesis, which is believed to have potential for providing anti-cancer, anti-inflammatory, blood-sugar-lowering and other beneficial cardiovascular effects.

### SUMMARY

According to some embodiments of the present invention, a beverage product includes water and a resveratrol solution. The resveratrol solution may include a carrier solvent and about 0.5 wt % to about 10 wt % resveratrol. In some embodiments, the resveratrol solution comprises about 2 wt % to about 5 wt % resveratrol. In certain embodiments, the carrier solvent is a food-grade solvent and in some embodiments comprises at least one of propylene glycol, ethanol, or glycerin. In some embodiments, the beverage product includes resveratrol in an amount of about 0.005 wt % to about 0.1 wt %.

In some embodiments, the beverage product includes an acidity adjuster. The acidity adjuster may be present in an amount necessary to result in a beverage product pH of about 2.2 to about 6.5. In some embodiments, the beverage product has a pH of about 2.5 to about 3.5. In certain embodiments, the beverage product includes at least one sweetener.

According to some embodiments of the present invention, a method of producing a beverage product includes adding a resveratrol solution to a beverage solution, where the resveratrol solution includes a carrier solvent and about 0.5 wt % to about 10 wt % resveratrol. In some embodiments, the resveratrol solution is added to the beverage solution prior to pasteurization of the beverage solution. In certain embodiments, the resveratrol solution is a final ingredient added to the beverage solution prior to pasteurization of the beverage solution. In some embodiments, the beverage product is a water-based beverage, a hot-filled water based beverage, a sterile processed beverage, a preserved cold-filled beverage, a carbonated beverage, a juice-containing beverage, or a post-fill heat processed beverage.

### DETAILED DESCRIPTION

Compositions and methods of the present invention relate to beverage products containing resveratrol. In some embodiments, resveratrol is incorporated in a carrier solvent prior to addition to a beverage solution. The concentration of resveratrol in water-based beverages is generally limited by the solubility of resveratrol in water. However, the addition of resveratrol to a beverage solution through the use of a carrier solvent may allow for incorporation of more resveratrol into a water-based beverage than would otherwise be soluble in the beverage product. In some embodiments, a beverage solution includes any mixture of one or more ingredients prior to obtaining a final beverage product.

I. Beverage Product

Beverage products of some embodiments of the present invention include water and resveratrol, and may optionally include sweeteners, acidulants, salts, flavors, colors, or other additional ingredients.

Water

Beverage products of the present invention include water. In some embodiments, beverage products include water from dairy. In some embodiments, beverage products include water from juice.

In some embodiments, a beverage product contains water in an amount of about 40 wt % to about 99.9 wt %; about 50 wt % to about 99.9 wt %; about 45 wt % to about 95 wt %; or about 50 wt % to about 90 wt %. In some embodiments, a beverage product contains water in an amount of about 40 wt %; about 45 wt %; about 50 wt %; about 55 wt %; about 60 wt %; about 65 wt %; about 70 wt %; about 75 wt %; about 80 wt %; about 85 wt %; about 90 wt %; about 95 wt %; about 99 wt %; or about 99.9 wt %.

Resveratrol

Beverage products of the present invention include resveratrol. In some embodiments, beverage products include concentrated resveratrol. In some embodiments, beverage products include purified resveratrol. Resveratrol may also be known as trans-resveratrol (CAS#501-36-0); (E)-resveratrol; 3,4′,5-Trehydroxy-trans-stilbene; 5-[(1E)-2-(4-Hydroxyphenyl)ethenyl]-1,3-benzenediol; cis-resveratrol (CAS#61434-67-1); or (Z)-resveratrol. As used here, the term resveratrol is understood to be inclusive of resveratrol isomers, biological precursors, glycosylation results (such as but not limited to piceid), and any formulation of resveratrol. An example of a suitable commercially available resveratrol product is Resvida™ supplied by DSM Corporate.

Resveratrol is a phytoalexin produced naturally by several plants when under attack by pathogens such as bacteria or fungi. Resveratrol may also be produced by chemical synthesis. Resveratrol may provide anti-cancer, anti-inflammatory, blood-sugar-lowering and other beneficial cardiovascular effects.

In some embodiments, a beverage product contains resveratrol in an amount of about 0.043 wt %. In some embodiments, a beverage product, contains resveratrol in an amount of about 0.005 wt % to about 0.1 wt %.

Carrier Solvent

In some embodiments, resveratrol is incorporated in a carrier solvent. Suitable carrier solvents include those in which resveratrol is more soluble than in water. In some embodiments, the carrier solvent is a food-grade solvent. Examples of suitable carrier solvents include but are not limited to propylene glycol, alcohols such as ethanol, glycerine, or combinations thereof.

In some embodiments, a carrier solvent includes resveratrol in an amount of about 0.1 wt % to about 20 wt %; about 0.2 wt % to about 17 wt %; about 0.3 wt % to about 15 wt %; about 0.4 wt % to about 12 wt %; about 0.5 wt % to about 10 wt %; about 0.6 wt % to about 9 wt %; about 0.7 wt % to about 8 wt %; about 0.8 wt % to about 7 wt %; about 0.9 wt % to about 6 wt %; about 1 wt % to about 5 wt %; about 2 wt % to about 5 wt % or about 2 wt % to about 4 wt %. In some embodiments, a carrier solvent includes resveratrol in an amount of about 0.1 wt %; about 0.2 wt %; about 0.3 wt %; about 0.4 wt %; about 0.5 wt %; about 0.6 wt %; about 0.7 wt %; about 0.8 wt %; about 0.9 wt %; about 1 wt % about 2 wt %; about 3 wt %; about 4 wt %; about 5 wt %; about 6 wt %; about 7 wt %; about 8 wt %; about 9 wt %; about 10 wt %; about 11 wt %; about 12 wt %; about 13 wt %; about 14 wt %; about 15 wt %; about 16 wt %; about 17 wt %; about 18 wt %; about 19 wt %; about 20 wt %; about 21 wt %; about 22 wt %; about 23 wt %; about 24 wt %; about 25 wt %; about 26 wt %; about 27 wt %; about 28 wt %; about 29 wt %; or about 30 wt %.

Sweetener

The beverage product of some embodiments of the present invention includes a sweetener. Any suitable sweetener or combination of sweeteners may be used in beverage product of some embodiments. In some embodiments, a beverage product includes nutritive sweeteners, non-nutritive sweeteners, or combinations thereof. Suitable sweeteners may include but are not limited to sucrose, fructose, glucose, high fructose corn syrup, acesulfame potassium, aspartame, neotame, saccharin, sucralose, stevioside, rebaudioside A, sugar alcohols such as sorbitol, erythritol, xylitol, lactitol, mannitol, isomalt, and maltitol, or combinations thereof.

A beverage product may include any amount of sweetener suitable to achieve the desired level of sweetness. In some embodiments, a beverage product includes sweeteners in an amount of about 0.002 wt % to about 30 wt %. In some embodiments, a beverage product includes high potency sweeteners in an amount of about 0.002 wt % to about 0.5 wt %; about 0.003 wt % to about 0.4 wt %; about 0.004 wt % to about 0.3 wt %; about 0.005 wt % to about 0.2 wt %; about 0.006 wt % to about 0.1 wt %; about 0.007 wt % to about 0.09 wt %; about 0.008 wt % to about 0.08 wt %; about 0.009 wt % to about 0.07 wt %; about 0.01 wt % to about 0.06 wt %; about 0.02 wt % to about 0.05 wt %; or about 0.03 wt % to about 0.04 wt %. In some embodiments, a beverage product includes high potency sweeteners in an amount of about 0.002 wt %; about 0.003 wt %; about 0.004 wt %; about 0.005 wt %; about 0.006 wt %; about 0.007 wt %; about 0.008 wt %; about 0.009 wt %; about 0.01 wt %; about 0.02 wt %; about 0.03 wt %; about 0.04 wt %; about 0.05 wt %; about 0.06 wt %; about 0.07 wt %; about 0.08 wt %; about 0.09 wt %; about 0.1 wt %; about 0.2 wt %; about 0.3 wt %; about 0.4 wt %; or about 0.5 wt %.

In some embodiments, a beverage product includes nutritive sweeteners in an amount of about 1 wt % to about 30 wt %; about 2 wt % to about 29 wt %; about 3 wt % to about 27 wt %; about 4 wt % to about 26 wt %; about 5 wt % to about 25 wt %; about 6 wt % to about 24 wt %; about 7 wt % to about 23 wt %; about 8 wt % to about 22 wt %; about 9 wt % to about 21 wt %; about 10 wt % to about 20 wt %; about 11 wt % to about 19 wt %; about 12 wt % to about 18 wt %; about 13 wt % to about 17 wt %; or about 14 wt % to about 16 wt %. In some embodiments, a beverage product includes nutritive sweeteners in an amount of about 1 wt %; about 2 wt %; about 3 wt %; about 4 wt %; about 5 wt %; about 6 wt %; about 7 wt %; about 8 wt %; about 9 wt %; about 10 wt %; about 11 wt %; about 12 wt %; about 13 wt %; about 14 wt %; about 15 wt %; about 16 wt %; about 17 wt %; about 18 wt %; about 19 wt %; about 20 wt %; about 21 wt %; about 22 wt %; about 23 wt %; about 24 wt %; about 25 wt %; about 26 wt %; about 27 wt %; about 28 wt %; about 29 wt %; or about 30 wt %.

Acidity Adjusters

The beverage product of some embodiments of the present invention includes an acidity adjuster. In some embodiments, the acidity of a beverage product may be adjusted to a desired level with any suitable acid or salt. Examples of suitable acid adjusters may include but are not limited to acidulants, salts, tartaric acid, tartaric salts, citric acid, citrate salts, fumaric acid, fumaric salts, phosphoric acid, phosphoric salts, acid juices, or combinations thereof.

In some embodiments, a beverage product contains an amount of acidity adjusters suitable to achieve a desired pH. In some embodiments, a beverage product contains acidity adjusters in an amount suitable to provide a beverage product pH of about 2.2 to 6.5, or about 2.5 to about 3.5. In some embodiments, a beverage product contains acidity adjusters in an amount suitable to provide a beverage product pH of about 2.2; about 2.4; about 2.6; about 2.8; about 3.0; about 3.2; about 3.4; about 3.6; about 3.8; about 4.0; about 4.2; about 4.4; about 4.6; about 4.8; about 5.0; about 5.2; about 5.4; about 5.6; about 5.8; about 6.0; about 6.2; about 6.4; or about 6.6.

Additional Ingredients

A beverage product of some embodiments of the present invention may include additional ingredients, for example, flavorings, colorants or preservatives. Any suitable flavorings may be included, such as natural or artificial fruit flavors, botanical flavors, other flavors, or mixtures thereof. Suitable flavorings may include but are not limited to extracts, reaction flavors, enzymatically derived, fermentation, biotechnology derived, and synthetic. Suitable classifications of flavorings may include but are not limited to extracts from the named fruit, extracts from the named fruit with other natural flavor, type, nature identical, and artificial. Examples of suitable flavorings may include but are not limited to merlot wine type flavor, black currant flavor, wildberry flavor, cabernet grape type flavor, pomegranate flavor, and pinot noir wine type flavor. Any suitable colorants may be used, including but not limited to fruit juice concentrate or vegetable juice concentrate.

Beverage products of the present invention may optionally include other additional ingredients, including generally, any of those typically found in beverage formulations. In some embodiments, a beverage product of the present invention includes one or more preservatives, caffeine, carbon dioxide, nutritional supplements, or combinations thereof.

II. Method of Producing Beverage Product

Methods of the present invention relate to the production of a beverage product containing resveratrol.

Resveratrol Solution

In some embodiments, resveratrol is incorporated in a carrier solvent, creating a resveratrol solution, before addition to a solution to form a beverage product. Suitable carrier solvents are described above.

In some embodiments, a resveratrol solution is prepared by gradually adding resveratrol to a carrier solvent. The carrier solvent may optionally be agitated and/or heated during addition of the resveratrol. In some embodiments, the temperature of the carrier solvent should be maintained at or below 185° F. during addition of the resveratrol.

Beverage Product

In some embodiments, the suspension or solution of resveratrol in a beverage is achieved by incorporating resveratrol in a carrier solvent to create a resveratrol solution, and adding the resveratrol solution to the beverage solution. The addition of resveratrol to a beverage solution through the use of a carrier solvent may allow for incorporation of more resveratrol into a water-based beverage product than would otherwise be soluble in the beverage product. In some embodiments, improved beverage product stability may be achieved through the incorporation of resveratrol through a resveratrol solution than by incorporation through alternative means.

In some embodiments, a beverage product is prepared by addition of a resveratrol solution, as described above, to a solution. Suitable beverage products and their solutions of the present invention may include but are not limited to water based beverages, hot-filled water based beverages, sterile processed beverages, juice-containing beverages, or retort or post-fill heat processed beverages.

In some embodiments, a resveratrol solution may be incorporated at any point in the beverage-making process prior to pasteurization or commercial sterilization. In some embodiments, a resveratrol solution is added to a smaller mixing vessel prior to transfer to a batch solution holding tank. In some embodiments, the resveratrol solution is added directly to a batch tank. In some embodiments, a resveratrol solution is added to a beverage stream via a conduit.

The ingredients may be added to a beverage solution in any suitable order. In some embodiments, a resveratrol solution is the last ingredient added to a beverage solution prior to pasteurization. In some embodiments, a beverage product is prepared by first adding water, sweetener(s), optional ingredients such as acidulants and/or salts, flavor and color, followed by a resveratrol solution.

Method of Manufacturing Beverage Product

In some embodiments, a beverage product of the present invention is produced with equipment including but not limited to a scale, an addition tank, a batch tank and a pasteurizer. First, ingredients according to the formulations of the present invention may be measured on a scale. The desired amount of certain ingredients may then be added to an addition tank. Metered water may be added to dissolve the ingredients and to wash the addition tank. Water added to the addition tank may be hot or cold.

In some embodiments, the contents of the addition tank may then be transferred to a batch tank. In some embodiments, certain ingredients are added directly to the batch tank, rather than to the addition tank. In some embodiments, a suitable batch tank is about 1,000 gallons to about 10,000 gallons. Once the desired ingredients are added to the batch tank, water is added to the batch tank to achieve the desired final volume.

Once completed, the beverage may be pumped from the batch tank through a pasteurizer. The beverage may then be packaged, for instance, in bottles.

### Exemplary Embodiment

The following is an exemplary embodiment of a beverage production. The sweeteners, erythritol and rebaudioside A at about 30% and 10% w/v respectively, may be dissolved in a small dissolution tank with heated water and agitation. The contents of the dissolution tank may then be transferred to the batch tank. Acidulants, tartaric acid and/or citric acid, may be added first to the dissolution tank with heated water and agitation, and then transferred to the batch tank. Additional acidulant may be added to bring the pH of the finished beverage within about 2.5 to 3.8. Flavors and colors around 2% and less than 2% w/v respectively, may be added to the dissolution tank with cool water and mild agitation, before transferring to the batch tank. A resveratrol solution in propylene glycol may then be slowly added to warm agitated water in the dissolution tank and transferred to the batch tank to a final resveratrol composition of 0.043% w/v. The batch tank may be filled with water to the final target volume and continually moderately agitated until further processing. The contents may be transferred to a continuous flow through a plate-type heat exchanger for sufficient time and temperate combination for effective pasteurization, such as 185° F. to 190° F. for about 30 seconds. The beverage may be filled into bottles and capped while hot, for example at 178° F. to 182° F.

As used herein, the term “about” is understood to mean±10% of the value referenced. For example, “about 0.8” is understood to literally mean 0.72 to 0.88.

### Examples

Beverage products were prepared using the following concentrations:

| | lb/1000 | | | |
|---|---|---|---|---|
| | gal | % lb/gal | g/mL | % metric |
| Erythritol | 292.08 | 29.21% | 0.035 | 3.50% |
| Rebaudioside-A | 0.71 | 0.07% | 0.000085 | 0.0085% |
| Tartaric Acid | 2 | 0.20% | 0.00024 | 0.024% |
| Resveratrol solution | 14.44 | 1.44% | 0.00173 | 0.17% |
| Amount of resveratrol | 0.433 | 0.0433% | 0.0000519 | 0.0052% |
| Natural Flavor - | 23.28 | 2.33% | 0.0006 | 0.060% |
| Formula 1 | | | | |
| COLOR - Formula 1 | 3.76 | 0.38% | 0.00045 | 0.045% |
| Natural Flavors | 21.53 | 2.15% | 0.0018 | 0.180% |
| Formula 2 | | | | |
| COLOR - Formula 2 | 2.5 | 0.25% | 0.0003 | 0.030% |
| Natural Flavor - | 20.27 | 2.03% | 0.00082 | 0.082% |
| Formula 3 | | | | |
| COLOR - Formula 3 | 1.25 | 0.13% | 0.00015 | 0.015% |

The individual formulations are as follows:

Formulation 1: Berry Bordeaux

| Order of | | | |
|---|---|---|---|
| addition | | | |
| Ingredient # | Ingredient: | Lbs | |
| 1 | Erythritol | 292.08 | |
| 2 | Rebaudioside-A | 0.71 | |
| 3 | Tartaric Acid | 2.00 | |
| 4 | Natural Flavors | 23.28 | |
| 5 | Fruit juice concentrate | 3.76 | |
| 6 | Resveratrol solution in Propylene Glycol | 14.44 | |
| 7 | Water QS to | 1000 | gal |

Formulation 2: Cabernet Grape

| Order of | | | |
|---|---|---|---|
| addition | | | |
| Ingredient # | Ingredient | Lbs | |
| 1 | Erythritol | 292.08 | |
| 2 | Rebaudioside-A | 0.71 | |
| 3 | Tartaric Acid | 2.00 | |
| 4 | Natural Flavors | 21.53 | |
| 5 | Fruit juice concentrate | 2.50 | |
| 6 | Resveratrol solution in Propylene Glycol | 14.44 | |
| 7 | Water QS to | 1000 | gal |

Formulation 3: Pomegranate pinot noir

| Order of | | | |
|---|---|---|---|
| addition | | | |
| Ingredient # | Ingredient | Lbs | |
| 1 | Erythritol | 292.08 | |
| 2 | Rebaudioside-A | 0.71 | |
| 3 | Tartaric Acid | 2.00 | |
| 4 | Natural Flavors | 20.27 | |
| 5 | Fruit juice concentrate | 1.25 | |
| 6 | Resveratrol solution in Propylene Glycol | 14.44 | |
| 7 | Water QS to | 1000 | gal |

The 1000 gallon batch formula beverage products were prepared using:

a main batch tank fitted with mixing blades, and

a smaller side dissolution tank fitted with mixing blades and piped to pump into the main batch tank.

First, approximately half the final batch water volume was pumped into the main batch tank. Agitation was commenced, with the speed set to the medium setting.

A small amount of heated water was pumped into the smaller side dissolution tank and the agitation speed was set to high. Ingredient #1, erythritol, was gradually added into this tank. A small amount of water was then used to rinse the container that held the weighed Ingredient #1 erythritol into the side dissolution tank. Once completely dissolved, the erythritol solution was pumped into the main batch tank.

Again, a small amount of the heated water was pumped into the same side dissolution tank and the agitation speed was set to high. Ingredient #2, rebaudioside A, was gradually added into this tank. A small amount of water was then used to rinse the container that held the weighed Ingredient #2 rebaudioside A into the side dissolution tank. Once completely dissolved, the rebaudioside A solution was pumped into the main batch tank.

Next, a small amount of heated water was pumped into the same side dissolution tank and the agitation speed was set to high. Ingredient #3, tartaric acid was gradually added into this tank. A small amount of water was then used to rinse the container that held the weighed Ingredient #3 tartaric acid into the side dissolution tank. Once completely dissolved, the tartaric acid solution was pumped into the main batch tank.

Ingredient #4, flavors, were added through the side dissolution tank, while maintaining moderate agitation. A small amount of water was then used to rinse the container that held the weighed Ingredient #4 flavor.

Ingredient #5, color, was gradually through the side dissolution tank, while maintaining moderate agitation. A small amount of water was then used to rinse the container that held the weighed Ingredient #5 color.

Next, the same side dissolution tank was partially filled with hot water, not exceeding 185° F. The agitation speed was set to high. Ingredient #6, a 3% resveratrol solution in propylene glycol, was then added slowly to the side tank while maintaining high agitation of the hot water. After the 3% resveratrol in propylene glycol was completely dissolved and confirmed as clear, the mixture was pumped into the main batch tank. If the mixture becomes cloudy after addition, it may be discarded and re-batched instead of pumping it to the main batch tank. The side dissolution tank was then rinsed with a small amount of water and pumped into the main batch tank.

The main batch tank was then filled to final volume (1000 gallons) with ambient water using continuous agitation.

We claim:

1. A beverage product comprising:
water and a resveratrol solution, wherein the resveratrol solution comprises a carrier solvent and about 0.5 wt % to about 10 wt % resveratrol.

2. The beverage product of claim 1, comprising resveratrol in an amount of about 0.005 wt % to about 0.1 wt %.

3. The beverage product of claim 1, wherein the carrier solvent comprises a food-grade solvent.

4. The beverage product of claim 1, wherein the carrier solvent comprises at least one of propylene glycol, ethanol, or glycerin.

5. The beverage product of claim 1, further comprising an acidity adjuster.

6. The beverage product of claim 5, wherein the acidity adjuster is present in an amount necessary to result in a beverage product pH of about 2.2 to about 6.5

7. The beverage product of claim 1, having a pH of about 2.5 to about 3.5.

8. The beverage product of claim 1, wherein the resveratrol solution comprises about 2 wt % to about 5 wt % resveratrol.

9. The beverage product of claim 1, further comprising at least one sweetener.

10. A method of producing a beverage product, comprising adding a resveratrol solution to a beverage solution, wherein the resveratrol solution comprises a carrier solvent and about 0.5 wt % to about 10 wt % resveratrol.

11. The method of claim 10, wherein the resveratrol solution is added to the beverage solution prior to pasteurization of the beverage solution.

12. The method of claim 10, wherein the resveratrol solution is a final ingredient added to the beverage solution prior to pasteurization of the beverage solution.

13. The method of claim 10, wherein the resveratrol solution comprises about 2 wt % to about 5 wt % resveratrol.

14. The method of claim 10, further comprising adding an acidity adjuster to the beverage solution.

15. The method of claim 14, wherein the acidity adjuster is added to the beverage solution in an amount necessary to result in a beverage product pH of about 2.2 to about 6.5.

16. The method of claim 10, wherein the beverage product has a pH of about 2.5 to about 3.5.

17. The method of claim 10, further comprising adding at least one sweetener.

18. The method of claim 10, wherein the beverage product comprises about 0.005 wt % to about 1 wt % resveratrol.

19. The method of claim 10, wherein the carrier solvent comprises at least one of propylene glycol, ethanol, or glycerin.

20. The method of claim 10, wherein the beverage product comprises at least one of a water-based beverage, a hot-filled water-based beverage, a preserved cold-filled beverage, a carbonated beverage, a sterile processed beverage, a juice-containing beverage, or a post-fill heat processed beverage.
